(19) United States
(12) Patent Application Publication
(10) Pub. No.: US 2023/0086694 A1
(43) Pub. Date: Mar. 23, 2023

(54) INDOOR NAVIGATION

(71) Applicant: BEIJING DIDI INFINITY TECHNOLOGY AND DEVELOPMENT CO., LTD., Beijing (CN)

(72) Inventors: Xiaoqiang TENG, Beijijng (CN); Pengfei XU, Beijing (CN); Chaowei MA, Beijing (CN); Bin XU, Beijing (CN); Jun ZHANG, Beijing (CN); Yiping MENG, Beijing (CN); Runbo HU, Beijing (CN); Hua CHAI, Beijing (CN)

(73) Assignee: BEIJING DIDI INFINITY TECHNOLOGY AND DEVELOPMENT CO., LTD., Beijing (CN)

(21) Appl. No.: 18/052,212

(22) Filed: Nov. 3, 2022

Related U.S. Application Data
(63) Continuation of application No. PCT/CN2020/093204, filed on May 29, 2020.

(51) Int. Cl. G01C 21/20; G01C 21/16; H04W 4/33; H04W 4/02

(52) U.S. Cl. CPC G01C 21/206; G01C 21/16; H04W 4/33; H04W 4/026; H04W 4/027

(57) ABSTRACT

In accordance with one implementation of the present disclosure, a new approach for determining a movement orientation of a user is proposed in indoor navigation. Generally speaking, a device orientation of a terminal device is obtained based on at least one signal stream collected from the terminal device carried by a moving user. A deviation degree is determined based on the at least one signal stream, here the deviation degree represents a deviation between a movement orientation of the user and an actual device orientation of the terminal device. The movement orientation is determined based on the device orientation in accordance with a determination that the deviation degree is below a threshold degree. With the above implementation, the movement orientation of the user is determined in a more effective an accurate way, and thus accuracy of the indoor navigation is increased.

### CROSS-REFERENCE TO RELATED APPLICATIONS

This application is a Continuation of International Application No. PCT/CN2020/093204, filed on May 29, 2020, the contents of which are hereby incorporated by reference.

### TECHNICAL FIELD

Implementations of the present disclosure generally relate to navigation applications, more specifically, to methods, devices, computer program product and computer-readable storage medium for indoor navigation.

### BACKGROUND

Navigation applications have been increasingly popular in recent years. A navigation application may be a computer software program installed on a terminal device equipped with a Global Positioning System (GPS) sensor. Based on signals received from GPS satellites and a map, the navigation application may provide a location of the terminal device. However, when a user of the navigation application enters into a building, the signals from the GPS satellites may be attenuated and scattered by roofs, walls and other objects of the building. Therefore, the navigation application cannot provide accurate indoor navigation.

Dedicated sensors are developed for measuring acceleration and orientation of a moving user. For example, terminal devices such as cell phones are equipped with those sensors and thus acceleration and orientation signals of the user may be detected. However, it is difficult to process these signals and obtain accurate movement of the user in an effective and convenience manner.

### SUMMARY

In accordance with one implementation of the present disclosure, a new approach for determining a movement orientation of a user is proposed in indoor navigation. Generally speaking, a device orientation of a terminal device is obtained based on at least one signal stream collected from the terminal device carried by a moving user. A deviation degree is determined based on the at least one signal stream, here the deviation degree represents a deviation between a movement orientation of the user and an actual device orientation of the terminal device. The movement orientation is determined based on the device orientation in accordance with a determination that the deviation degree is below a threshold degree. With the above implementation, the movement orientation of the user is determined in a more effective and accurate way, and thus accuracy of the indoor navigation is increased.

It is to be understood that the Summary is not intended to identify key or essential features of implementations of the present disclosure, nor is it intended to be used to limit the scope of the present disclosure. Other features of the present disclosure will become easily comprehensible through the description below.

### BRIEF DESCRIPTION OF THE DRAWINGS

The details of one or more implementations of the present disclosure are set forth in the accompanying drawings and the description below. Other features, aspects, and advantages of the disclosure will become apparent from the description, the drawings, and the claims, wherein:

FIG. 1 illustrates a block diagram of an environment in which an example implementation of the present disclosure may be implemented;

FIG. 2 illustrates a flowchart of an method for identifying a stepping event in accordance with an example implementation of the present disclosure;

FIG. 3 illustrates a block diagram of a procedure for processing an acceleration signal stream based on two time windows in accordance with an example implementation of the present disclosure;

FIG. 4 illustrates a block diagram of a procedure for determining a deviation in accordance with an example implementation of the present disclosure;

FIG. 5 illustrates a block diagram of a procedure for determining a step intensity associated with movements of a first time window and a second time window in accordance with an example implementation of the present disclosure;

FIG. 6 illustrates a block diagram of curves of step intensities determined from the acceleration signal stream in accordance with an example implementation of the present disclosure;

FIG. 7 illustrates a block diagram of a procedure for determining an acceleration amplitude in accordance with an example implementation of the present disclosure;

FIG. 8 illustrates a block diagram of a procedure for determining a step length in accordance with an example implementation of the present disclosure;

FIG. 9 illustrates a block diagram of an environment in which an example implementation of the present disclosure may be implemented;

FIG. 10 illustrates a block diagram of a procedure for determining a movement orientation of a user in accordance with an example implementation of the present disclosure;

FIG. 11 illustrates a flowchart of a method for determining a movement orientation of a user in accordance with an example implementation of the present disclosure;

FIG. 12 illustrates a block diagram of a procedure for determining a movement orientation of a user in accordance with an example implementation of the present disclosure;

FIG. 13 illustrates a block diagram of a step window associated with a stepping event of a user in accordance with an example implementation of the present disclosure;

FIG. 14 illustrates a block diagram of a trajectory of a user in accordance with an example implementation of the present disclosure; and

FIG. 15 illustrates a block diagram of a device suitable for implementing one or more implementations of the present disclosure.

Throughout the figures, same or similar reference numbers will always indicate same or similar elements.

### DETAILED DESCRIPTION

Principle of the present disclosure will now be described with reference to some example implementations. It is to be understood that these implementations are described only for the purpose of illustration and help those skilled in the art to understand and implement the present disclosure, without suggesting any limitations as to the scope of the disclosure. The disclosure can be implemented in various manners other than the ones describe below.

As used herein, the term “include” and its variants are to be read as open terms that mean “include, but is not limited to”. The term “based on” is to be read as “based at least in part on”. The term “a” is to be read as “one or more” unless otherwise specified. The term “one implementation” and “an implementation” are to be read as “at least one implementation”. The term “another implementation” is to be read as “at least one other implementation”. Moreover, it is to be understood that in the context of the present disclosure, the terms “first”, “second” and the like are used to indicate individual elements or components, without suggesting any limitation as to the order of these elements. Further, a first element may or may not be the same as a second element. Other definitions, explicit and implicit, may be included below.

Navigation applications are widely installed in terminal devices, and GPS sensors in the terminal devices may receive signals from GPS satellites and provide locations of the terminal device. However, when a user of the terminal device enters into a building, the signals may be weaken and thus become useless. Recently, Inertial Measurement Unit (IMU) sensors have been equipped in terminal devices, and signal streams collected from the IMU sensors may be processed to determine movement of a moving user that carries the terminal device.

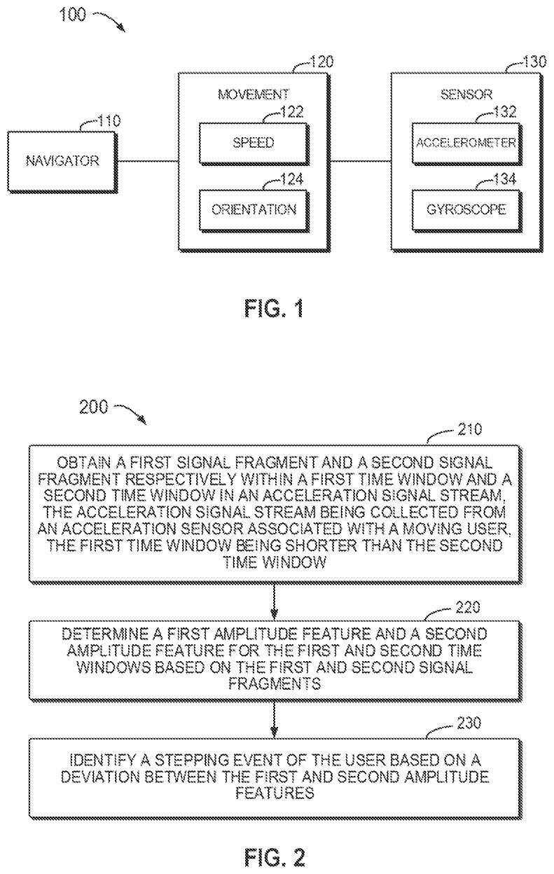

Reference will be made to FIG. 1 for a working environment of the present disclosure. FIG. 1 illustrates a block diagram 100 of an environment in which an example implementation of the present disclosure may be implemented. In FIG. 1, a navigator 110 may be installed in a terminal device, and a sensor 130 may be equipped in the terminal device of the user. Here, the sensor 130 may comprise an accelerometer 132 for collecting an acceleration signal stream and a gyroscope 134 for collecting an orientation signal stream. Next, the signal stream may be processed to determine a movement 120 including a speed 122 and an orientation 124 of the user. Further, the movement 120 may be provided to the navigator 110 for indoor navigation.

A Pedestrian Dead Reckoning (PDR) approach has been proposed for the indoor navigation. The PDR approach involves three main steps: 1) identifying a stepping event of a user, 2) determining a step length of the user, and 3) determining an orientation of the user. Here, the stepping event refers to an event that the user extends his/her leg and walks one step. As determining the step length and the orientation are both based on the identified stepping event, stepping event identification becomes a foundation for the indoor navigation. Peak detection and zero-crossing detection algorithms are developed for identifying the stepping event from the signal stream. However, due to noise and bias from the sensor 130, the signal stream should be filtered first. Further, it is hard to build criteria for detecting the peak and zero in the filtered signal stream.

In order to at least partially solve the above and other potential problems, a new method and device for identifying a stepping event are provided herein. In accordance with an example implementation of the present disclosure, two time windows with different lengths are utilized for processing the signal stream collected from the sensor 130. As the two time windows have different widths, signal fragments respectively within the two time windows show different patterns. Then, a stepping event may be identified from the signal stream based on a comparison of the signal fragments. With the above implementation, there is no need for filtering the noise and bias in the signal stream and identify the peak and zero. Instead, the stepping event may be identified in a more efficient and convenience manner.

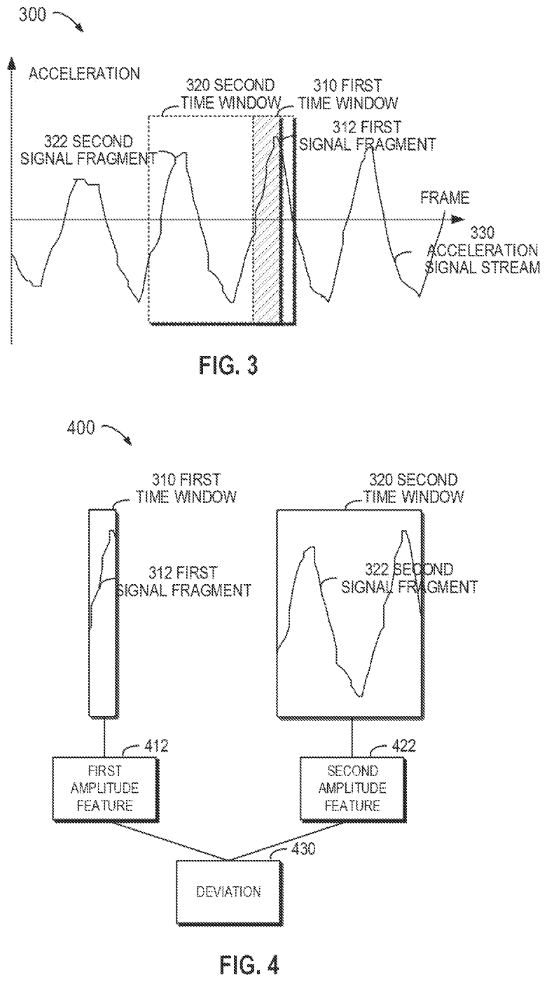

Reference will be made to FIG. 2 for a detailed description of implementations of the present disclosure. FIG. 2 illustrates a flowchart of a method 200 for identifying a stepping event in accordance with an example implementation of the present disclosure. At a block 210, a first signal fragment and a second signal fragment are obtained, the first and second signal fragments are respectively within a first time window and a second time window in an acceleration signal stream. Here, the acceleration signal stream is collected from an acceleration sensor associated with a moving user, and the first time window is shorter than the second time window. Reference will be made to FIG. 3 for details about obtaining the first and second signal fragments.

FIG. 3 illustrates a block diagram 300 of a procedure for processing an acceleration signal stream based on two time windows in accordance with an example implementation of the present disclosure. In FIG. 3, an acceleration signal stream 330 is illustrated, where a horizontal axis represents frames in the acceleration signal stream 330, and the vertical axis represents amplitudes of the acceleration. The acceleration signal stream 330 may be collected from an acceleration sensor such as the accelerometer 132 equipped in a terminal device of the user. As the user walks, the acceleration sensor may collect the acceleration continuously and output the acceleration signal stream 330. The acceleration sensor may collect the signal at a predefined frequency, and the frequency may vary depending on a type of the sensor. In one example, the frequency may be of 50 Hz, which means that the sensor collects 50 frames per second. In another example, the frequency may be of another value.

A first time window 210 (illustrated by a shaded block) and a second time window 220 (illustrated by a blank block) are defined, and the first time window 310 is shorter than the second time window 320. A first signal fragment 312 and a second signal fragment 322 are obtained within the first and second time windows 310 and 320 in the acceleration signal stream 330, respectively. Here, the first signal fragment 212 is a portion of the acceleration signal stream 330 within the first time window 310, and the second signal fragment 322 is a portion of the acceleration signal stream 330 within the second time window 320.

During the movement of the user, acceleration amplitudes at different frames may vary in the acceleration signal stream 330. Usually, a change in a short time window is more dramatic than that in a long time window. Therefore, the first and second signal fragments 312 and 322 may involve different amplitude changes and may help to identify a stepping event.

In one example implementation of the present disclosure, the first time window 310 may be within the second time window 320. Although FIG. 3 shows an example where the first time window 310 is in the middle of the second time window 320, the first time window 310 may be anywhere. In another example implementation, the first time window 310 may be at the beginning, at the end of the second time window 320, or even outside the second time window 320. For example, the first and second time windows 310 and 320 may have a same beginning or end. In one implementation, the first and second time windows 310 and 320 may have respective lengths of 20 frames and 100 frames. In another example, the lengths may be set to other values and may be represented by another format such as 0.2 second and 1 second.

It is to be understood that FIG. 3 just illustrates a situation associated with one time point during the movement of the user. As the user walks, the first and second time windows 310 and 320 may move forward along the acceleration signal stream 330, and more signal fragments may be obtained from each movement of the two time windows. As the first time window 310 is included in the second time window 320, the second signal fragment 322 may include more acceleration information near the first time window 310. Therefore, a comparison between the two signal fragments may help to identify changes in amplitudes caused by the stepping event more effectively.

Having described details about obtaining the first and second signal fragments 312 and 322, reference will be made back to FIG. 3 for processing the first and second signal fragments 312 and 322. At a block 320 in FIG. 3, a first amplitude feature and a second amplitude feature are determined for the first and second time windows 310 and 320 based on the first and second signal fragments 312 and 322, respectively. Here, the first amplitude feature represents a level of amplitudes in the first signal fragment 312, and reference will be made to FIG. 4 for more information.

FIG. 4 illustrates a block diagram 400 of a procedure for determining a deviation in accordance with an example implementation of the present disclosure. A first amplitude feature 412 may be determined based on an average value of the first signal fragment 312. Supposing the first signal fragment 312 includes n1 frames and an amplitude at the i^{th} frame is represented as ampᵢ¹, the first amplitude feature 412 may be represented based on Formula 1 as below.

$${a}_{a v g}^{1} = \frac{{Σ}_{i = 1}^{n 1} {amp}_{i}^{1}}{n 1} \qquad Formula 1$$

Where a_{avg}¹ represents the first amplitude feature 412 for the first time window 310, n1 represents the number of frames included in the first time window 310, ampᵢ¹ represents an amplitude at the i^{th} frame in the first signal fragment 312.

The second amplitude feature 422 may be determined in a similar manner based on Formula 2 as below.

$${a}_{a v g}^{2} = \frac{{Σ}_{i = 1}^{n 2} {amp}_{i}^{2}}{n 2} \qquad Formula 2$$

Where aₐᵥₕ² represents the second amplitude feature 422 for the second time window 320, n2 represents the number of frames included in the second time window 320, and ampᵢ² represents an amplitude at the i^{th} frame in the second signal fragment 322.

It is to be understood that the above Formulas 1 and 2 are just examples for determining the first and second amplitude features 412 and 422. Alternatively and/or in addition to, the first and second amplitude features 412 and 422 may be determined based on an average of a square of the amplitudes, or another formula that may reflect respective amplitudes within respective time windows.

For ease of description, the first and second amplitude features 412 and 422 may be represented by frame identification of the end frames. Supposing both of the first and second time windows 310 and 320 end at the j^{th} frame in the acceleration signal stream 330, the first and second time windows 310 and 320 may be called as the first and second windows for the j^{th} frame, and the first and second amplitude features 412 and 422 may be called as the first and second amplitude features for the j^{th} frame. Further, the first and second amplitude features 412 and 422 may be compared, and a deviation 430 may be determined therebetween.

Referring back to FIG. 3 again, at a block 330, a stepping event of the user is identified based on the deviation 430 between the first and second amplitude features 412 and 422. In one example implementation of the present disclosure, the deviation is also related to a frame and a deviation at the j^{th} frame may be determined based on a difference between the first and second amplitude features 412 and 422 according to Formula 3 as below.

devⱼ=a_{avg}¹−a_{avg}² Formula 3

Where devⱼ represents the deviation 430 at the j^{th} frame in the acceleration signal stream 330, a_{avg}¹ and a_{avg}² represent the first and second amplitude features 412 and 422 for the j^{th} frame, respectively. Continuing the above example, when the first and second time windows 310 and 320 have the same end frame, the j^{th} frame may be the end frame.

It is to be understood that the above Formula 3 is just an example for determining the deviation 430. Alternatively and/or in addition to, the deviation 430 may be determined based on any of Formulas 4 and 5 as below.

devⱼ=(a_{avg}¹)²−(a_{avg}¹) ² Formula 4

devⱼ=\sqrt{(a_{avg}¹)²−(a_{avg}¹)²} Formula 5

In Formulas 4 and 5, symbols have the same meaning as those in Formula 3 and details will be omitted.

As the change in the first time window 310 may be more dramatic than the second time window 320, the stepping event may be easily identified based on the deviation 430. In one example implementation of the present disclosure, a stepping event may be identified at the j^{th} frame if the deviation 430 exceeds a threshold deviation, and Formula 6 may be used to identify the stepping event at the j^{th} frame in the acceleration signal stream 330. Here, the threshold deviation may be determined based on a historical experience in advance.

$${S}_{j}^{dev} = \{ \begin{matrix}1 , & {dev}_{j} > {TH}_{dev} \\ 0 , & otherwise\end{matrix} \qquad Formula 6$$

Where Sⱼ^{dev} represents whether a stepping event is identified at the j^{th} frame in the acceleration signal stream 330 based on the deviation 430, devⱼ represents the deviation 430 at the j^{th} frame in the acceleration signal stream 330, and TH_{dev}, represents a threshold deviation.

As the deviation 430 is between the first and second amplitude feature 412 and 422 from the same acceleration signal stream suffered by the same noise and bias, the deviation 430 may be less sensitive to the noise and bias, which results in a more reliable identification of the stepping event. Compared with the existing PDR approach based on the peak and zero detection, the present disclosure may reduce impacts of the noise and bias and thus increase the accuracy and performance in identifying the stepping event.

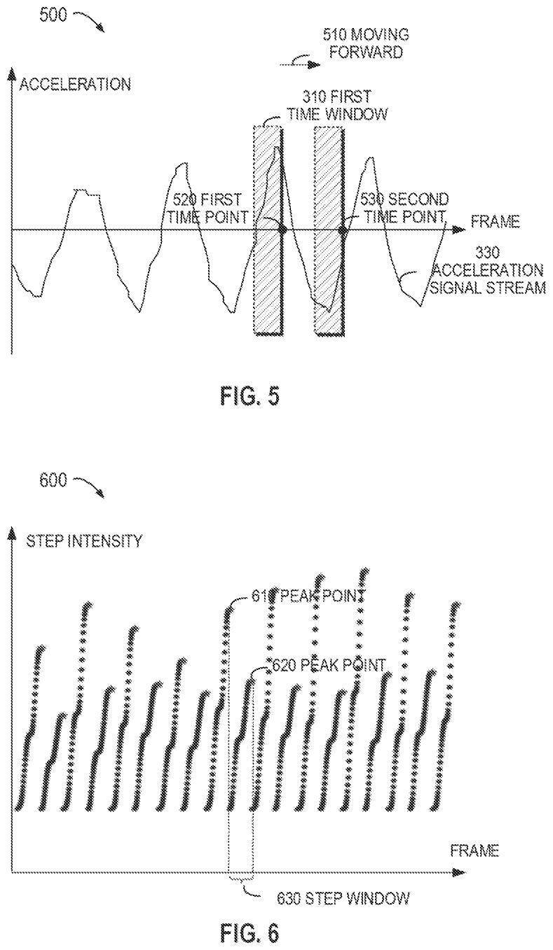

It is to be understood that the above Formula 6 is just an example for identifying a stepping event directly based on the deviation 430 related to a single time point when the user walks. In other example implementations of the present disclosure, the stepping event may be further determined based on deviations determined in other ways. In one example implementation of the present disclosure, the first and second time windows 310 and 320 may move forward along the acceleration signal stream 330, respectively. Then, a step intensity may be determined based on an accumulation of multiple deviations for multiple time points when the user walks. Reference will be made to FIG. 5 for more details.

FIG. 5 illustrates a block diagram 500 of a procedure for determining a step intensity associated with movements of a first time window and a second time window in accordance with an example implementation of the present disclosure. For simplicity, FIG. 5 illustrates only the movement of the first time window 310, and the movement of the second time window 320 is similar and thus is omitted. As the user walks, more acceleration signal stream will be obtained and the first time window 310 may move forward from a first time point 520 to a second time point 530 as indicated by an arrow 510. Here, the first window 310 may move forward by one or more frames in the acceleration signal stream 330 at a time.

Supposing the first and second time windows 310 and 320 have the same end frame, the end frame may cover a group of frames during movement. Therefore, the step intensity may be determined for the group of frames. Specifically, a first group of signal fragments may be obtained within the first time windows 310 during the movement, similarly, a second group of signal fragments may be obtained within the second time windows 320. Further, deviations related to the group of frames may be summed for determining the step intensity.

In one example implementation of the present disclosure, a first group of amplitude features and a second group of amplitude features may be determined based on the first and second groups of signal fragments, respectively. As the first and second time windows 310 and 320 move together, a deviation at each frame during the movement may be determined. Supposing the movement covers a group of m frames, a deviation may be determined for the k^{th} frame in the group of frames. At this point, a summation of a group of deviations between the first and second groups of amplitude features may be determined from Formula 7 as below.

intensityⱼ=Σₖ₌₁^{m} (devₖ)² Formula 7

Where intensityⱼ represents a step intensity for a group of frames that ends at the j^{th} frame in the acceleration signal stream 330, m represents the number of frames included in the group of frames, and devₖ represents a deviation for the k^{th} frame in the group of frames, which is determined based on the first and second signal fragments associated with the k^{th} frame according to any of Formulas 3 to 5.

It is to be understood that the above Formula 7 is just an example for determining the step intensity. In another example implementation of the present disclosure, the step intensity may be determined based on any of Formulas 8 to 11 as below.

intensityⱼ=Σₖ₌₁^{m}devₖ Formula 8

intensityⱼ=Σₖ₌₁^{m}devₖΔt Formula 9

intensityⱼ=Σₖ₌₁^{m}(devₖ)²Δt Formula 10

intensityⱼ=\sqrt{Σₖ₌₁^{m}(devₖ)²Δt} Formula 11

Where symbols in Formulas 8 to 11 have the same meaning as those in Formula 7, and Δt represents a sampling interval of the acceleration signal stream 330.

With the above implementation, deviations related to a group of frames during a time duration are considered in determining the stepping event when the user walks, and continuous changes in the amplitudes of the acceleration signal stream 330 may be monitored for the stepping event identification. Therefore, incorrect identification caused by a single deviation related to a single time point may be reduced, and the accuracy and performance for stepping event identification may be further enhanced.

In one example implementation of the present disclosure, the stepping event may be identified based on a comparison between the step intensity and a threshold intensity according to Formula 12, here the threshold intensity may be determined based on a historical experience.

$${S}_{j}^{intensity} = \{ \begin{matrix}1 , & {intensity}_{j} > {TH}_{intensity} \\ 0 , & otherwise\end{matrix} \qquad Formula 12$$

Where Sⱼ^{intensity} represents whether a stepping event is identified based on the step intensity at the j^{th} frame in the acceleration signal stream 330, intensityⱼ represents a step intensity associated with the j^{th} frame in the acceleration signal stream 330, and TH_{intensity} represents a threshold intensity.

In one example implementation of the present disclosure, if the step intensity is below the threshold intensity, the first and second time windows 310 and 320 may move forward by another frame to obtain a new step intensity for a new group of frames including more frames. If the step intensity for the group of frames exceeds the threshold intensity, a stepping event is identified (for example, at the j^{th} frame). Once the stepping event is identified, the group of frames may be reset and begin at a frame following the group of frames. At this point, the first and second time windows 310 and 320 may continuously move forward along the acceleration signal stream 330 for identifying a further stepping event. Reference will be made to FIG. 6 for more details about the step intensity.

FIG. 6 illustrates a block diagram 600 of curves of step intensities determined from the acceleration signal stream 330 in accordance with an example implementation of the present disclosure. In FIG. 6, the horizontal axis represents frames in the acceleration signal stream 330, and the vertical axis represents the step intensity that are determined based on the above formulas. Usually, the strength of two legs of the user may be different, and thus a peak value for one leg may be different from a peak value for the other. Curves of the step intensities shows periodically patterns, where a star icon (such as a peak point 610 and a peak point 620) represents a peak value in the step intensities, and a dot icon represents a non-peak value in the step intensities. In FIG. 6, frames between two successive peak points 610 and 620 may be identified as a step window 630 for a stepping event. Alternatively and/or in addition to, valley values in the step intensities may also be used to identify a stepping event.

It is to be understood that curves of step intensities in FIG. 6 are just examples, and curves determined for other users may show different patterns. For example, the curves for other users may show greater peak values and a higher frequency. With the above implementations, deviations related to a time duration may be considered for identifying the stepping event. Accordingly, long-term habits of the user behavior may be monitored, and errors caused by accident may be reduced.

In one example implementation of the present disclosure, the above methods for identifying the stepping event may be combined. For example, identifications based on the single deviation and the step intensity may be combined together for an enhanced identification. Specifically, a stepping event may be identified at the j^{th} frame in the acceleration signal stream 330 based on Formula 13 as below.

Sⱼ^{final}={j|Sⱼ^{dev}∩Sⱼ^{intensity}} Formula 13

Where Sⱼ^{final} a final result of whether a stepping event is identified at the j^{th} frame in the acceleration signal stream 330, Sⱼ^{dev} represents a result determined based on Formula 6, and Aⱼ^{intensity} represents a result determined based on Formula 12. With the above implementations, both of the single deviation and the step intensity may be considered in identifying the stepping event. Accordingly, errors caused by accident may be further reduced.

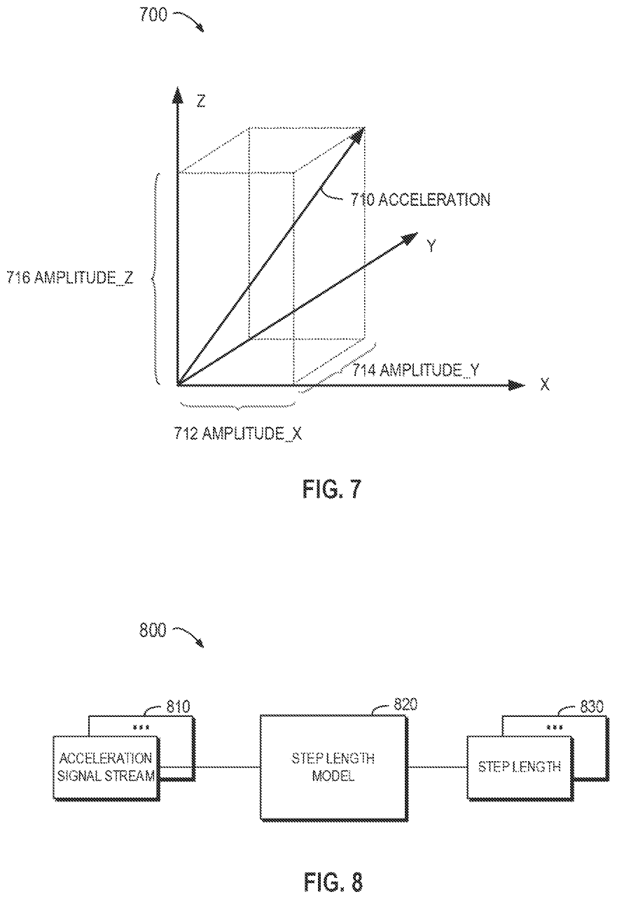

The above paragraphs have described details about identifying the stepping events. Afterwards, the identified stepping events may be further verified based on any of an acceleration amplitude of the acceleration signal stream 330 and a frequency limitation. Reference will be made to FIG. 7, which figure illustrates a block diagram 700 of a procedure for determining an acceleration amplitude in accordance with an example implementation of the present disclosure. Usually, the acceleration sensor may collect signals in three dimensions, and thus the amplitudes in x, y, z dimensions may be utilized to determining an acceleration amplitude for a frame in the acceleration signal stream 330.

As illustrated in FIG. 7, at the j^{th} frame in the acceleration signal stream 330, acceleration 710 relates to x, y, and z dimensions, and thus amplitude_x 712, amplitude_y 714, and amplitude_z 716 may be used to determine the acceleration amplitude for the j^{th} frame based on Formula 14 as below.

$${a}_{j} = \sqrt{{amplitude\_x}_{j}^{2} + {amplitude\_y}_{j}^{2} + {amplitude\_z}_{j}^{2}} \qquad Formula 14$$

Where aⱼ represents the acceleration amplitude associated with the j^{th} frame in the acceleration signal stream 330, and amplitude_xⱼ, amplitude_yⱼ and amplitude_zⱼ represent amplitudes in the x, y, and z dimensions, respectively.

Further, the stepping event may be verified based on a comparison between the acceleration amplitude and a threshold amplitude according to Formula 15, here the threshold amplitude may be determined based on a historical experience.

$${S}_{j}^{amplitude} = \{ \begin{matrix}1 , & {a}_{j} > {TH}_{amplitude} \\ 0 , & otherwise\end{matrix} \qquad Formula 15$$

Where Sⱼ^{amplitude} represents whether a stepping event is identified based on the acceleration amplitude at the j^{th} frame in the acceleration signal stream 330, aⱼ represents the acceleration amplitude associated with the j^{th} frame in the acceleration signal stream 330, and TH_{amplitude} represents a threshold amplitude.

According to the above Formula 15, if an acceleration amplitude for a frame, at which the stepping event is identified, exceeds the threshold amplitude, then the stepping event may be verified. With this implementation, more accuracy may be brought into the stepping event identification.

In one example implementation of the present disclosure, identifications based on the single deviation, the step intensity, and the acceleration amplitude may be combined together for a further enhanced identification. Specifically, a stepping event may be identified at the j^{th} frame in the acceleration signal stream 330 based on Formula 16 as below.

Sⱼ^{final}={j|Sⱼ^{dev}∩Sⱼ^{intensity}∩Sⱼ^{amplitude}} Formula 16

Where Sⱼ^{final} a final result of whether a stepping event is identified at the j^{th} frame in the acceleration signal stream 330, Sⱼ^{dev} represents a result determined based on Formula 6, Sⱼ^{intensity} represents a result determined based on Formula 12, and Sⱼ^{amplitude} represents whether a stepping event is verified based on Formula 15. With the above implementations, the accuracy and performance of the stepping event identification may be further enhanced.

In one example implementation of the present disclosure, the stepping event may be verified according to a frequency limitation. The frequency limitation may be defined according to the historical experience. Usually, the historical experience may show that a frequency of a common walk is one to three steps per second. If the frequency is out of the frequency limitation, then a warning may be provided. Supposing a frequency of the stepping events is 2 steps per second, the stepping events may be verified. If a frequency is 5 steps per second, then the stepping event will not be verified and a warning will be outputted. With the above implementation, the identified stepping events may be verified based on common senses about the frequency. Accordingly, more reliable stepping event identification may be provided.

It is to be understood that identifying the stepping event is just a beginning of the indoor navigation. Once a stepping event is identified, a step length associated with the stepping event may be obtained. Reference will be made to FIG. 8 for more information on step length determination. FIG. 8 illustrates a block diagram 800 of a procedure for determining a step length in accordance with an example implementation of the present disclosure. In one example implementation of the present disclosure, a machine learning model may be built for determining the step length. In FIG. 8, a sample dataset including acceleration signal streams 810 collected from reference users and step lengths 830 of the reference users may be used for training a step length model 820.

In one example implementation of the present disclosure, the step length model 820 characterizes a polynomial association between a step length of a reference user in the reference users, an extreme value, an average value, and a frequency of an acceleration signal stream collected by an acceleration sensor associated with the reference user. For example, the step length model may be determined based on Formula 17 as below.

$${Length}^{step} = a * \sqrt[u]{{a}_{max}^{step} + {a}_{min}^{step}} + b * f + c * {\sum }_{i = 0}^{m} {( {a}_{i} - {a}_{a v g}^{step} )}^{2} Δ t + d \qquad Formula 17$$

Where Length^{step} represents a step length , a, b, c, d and u represent hyper-parameters, respectively, aₘₐₓ^{step}, aₘᵢₙ^{step}, and a_{avg}^{step} represent the maximum, minimum, and the average amplitude of the acceleration signal within the determined step window, respectively, f represents a walking frequency associated with the stepping event, m represents the number of frames included in the step window, and Δt represents a sampling interval of the acceleration signal stream 330.

With the above implementation, the polynomial association may be trained in a simple manner. In one example implementation of the present disclosure, values related to Length^{step}, aₘₐₓ^{step}, aₘᵢₙ^{step}, a_{avg}^{step}, f, m, and Δt may be obtained for training the step length model 820. Once the step length model 820 is successfully trained, the acceleration signal stream 330 may be easily processed and then inputted into the step length model 820 for a step length determination.

In order to obtain the step length for the user, extreme values (including a maximum and a minimum) within the stepping window associated with the stepping event may be identified from the acceleration signal stream 330, an average value for the stepping window may be determined, and a frequency of the stepping event may also be determined. Further, the step length may be determined based on the step length model 820, the extreme value, the average value, and the frequency. In other words, the acceleration signal stream 330 may be processed for extracting parameters related to aₘₐₓ^{step}, aₘᵢₙ^{step}, a_{avg}^{step}, f, m, and Δt. Next, the extracted parameters may be inputted into the step length model 820 and then a step length may be outputted.

It is to be understood that the above Formula 17 is just an example model for the step length. In other implementations, based on various types of machine learning techniques, the step length model 820 may be represented by another form other than the polynomial association.

In one example implementation of the present disclosure, behavior modes of the user may be considered in identifying the stepping event and/or determining the step length. For example, the walking modes may be classified into walking, stroll, still and sway modes. Accordingly, various models may be trained based on the above behavior modes so as to obtain more accurate stepping events and associated step lengths. In one example implementation of the present disclosure, movement orientations related to the identified stepping events may be determined. In turn, a speed and a trajectory of the user may be determined.

In one example implementation of the present disclosure, a speed of the user may be determined based on the step length and the time duration associated with the step length. Alternatively and/or in addition to, the speed may be determined based on multiple step lengths and multiple time durations. For example, a length summation may be calculated from the multiple step lengths and a time summation may be calculated from the multiple time durations. Next, the speed may be determined according to the length summation and the time summation.

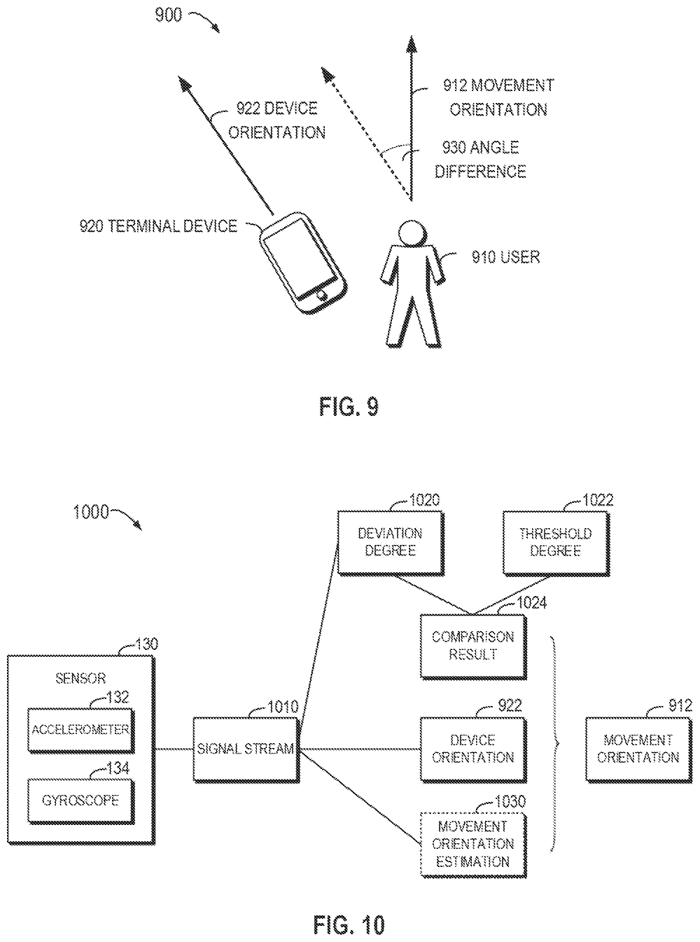

Having described how to identify the stepping event and determine the step length associated with the stepping event, hereinafter, reference will be made to FIG. 9 for details about determining a movement orientation of the user. FIG. 9 illustrates a block diagram 900 of an environment in which an example implementation of the present disclosure may be implemented. In FIG. 9, a user 910 carries a terminal device 920 in his/her pocket or holds it in his/her hand. However, a movement orientation 912 of the user 910 may be different from a device orientation 922 of the terminal device 920. Usually, there may exist an angle difference 930 between the movement orientation 912 and the device orientation 922.

By now, approaches have been proposed for determining the movement orientation of the user. As the device orientation 922 may be determined from dedicated sensors in the terminal device 920, and the device orientation 922 is usually taken as the movement orientation 912. However, the device orientation 922 and the movement orientation 912 are not always the same and the angle difference 930 may also change during the movement. At this point, how to detect the movement orientation 912 of the user 910 becomes a focus.

In order to at least partially solve the above and other potential problems, a new method and device for determining a movement orientation are provided. According to implementations of the present disclosure, a deviation degree is defined for representing a deviation between the movement orientation 912 of the user 910 and an actual device orientation of the terminal device 920. If the deviation degree is below a threshold degree, the movement orientation 912 may be determined based on the device orientation 920. Otherwise, the movement orientation 912 may be estimated based on machine learning techniques.

Reference will be made to FIG. 10 for a brief description of the present disclosure. FIG. 10 illustrates a block diagram 1000 of a procedure for determining a movement orientation of a user in accordance with an example implementation of the present disclosure. As illustrated in FIG. 10, the sensor 130 may provide a signal stream 1010. Here, the sensor 130 may comprise an accelerometer 132 for collecting an acceleration signal stream and a gyroscope 134 for collecting an orientation signal stream. The device orientation 922 of the terminal device 920 may be obtained from the signal stream 1010 collected from the sensor 130 equipped in the terminal device 920.

Further, a deviation degree 1020 is determined based on the signal stream 1010. The greater the deviation degree 1010 is, the greater the angle difference 930 may be. A threshold angle 1022 may be predefined based on the historical experience, and then the deviation degree 1020 may be compared with the threshold degree 1022 to obtain a comparison result 1024. Based on the comparison result 1024, one orientation may be selected from the device orientation 922 and a movement orientation estimation 1030 as the movement orientation 912.

With the above implementation, the deviation degree 1020 may measure whether the movement orientation 912 of the user 910 is consistent with an actual device orientation of the terminal device 920. The movement orientation 912 is determined based on the device orientation 922 only if the two orientations are in consistent with each other. Compared with the solutions for directly using the device orientation 922 as the movement orientation 912, the movement orientation 912 may be determined in a more accurate and reliable manner.

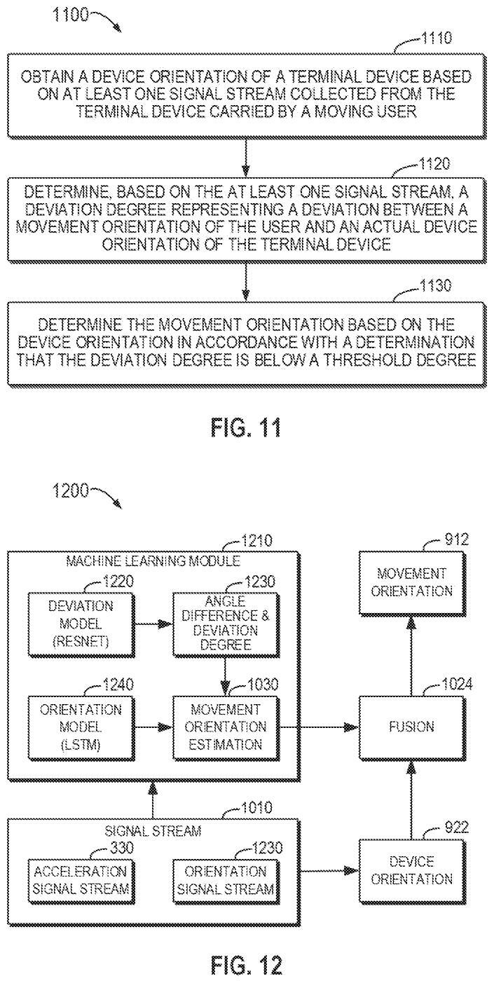

Reference will be made to FIG. 11 for a detailed description of implementations of the present disclosure. FIG. 11 illustrates a flowchart of a method 1100 for determining a movement orientation of a user in accordance with an example implementation of the present disclosure. At a block 1110, the device orientation 922 of the terminal device 920 is obtained based on at least one signal stream collected from the terminal device 920 carried by a moving user. In one example implementation of the present disclosure, the terminal device 920 may be equipped with the accelerometer 132 and the gyroscope 134. Therefore, the at least one signal stream may comprise an acceleration signal stream collected by the accelerometer 132 and an orientation signal stream collected by the gyroscope 134.

Referring to FIG. 12 for more details about determining the device orientation 922. FIG. 12 illustrates a block diagram 1200 of a procedure for determining a movement orientation of a user in accordance with an example implementation of the present disclosure. Here, the device orientation 922 may be determined from the signal stream 1010 including the acceleration signal stream 330 and an orientation signal stream 1230. Here, the orientation signal stream 1230 may be represented by an angular velocity collected from the gyroscope 134. In one implementation of the present disclosure, there is no restriction on methods that are used to obtain the device orientation 922. Instead, a variety of methods that have been known and/or that will be developed in the future can be used.

In one example, the device orientation 922 may be determined based on the IMU orientation. Alternatively and/or in addition to, a machine learning model characterizing an association between the device orientations of reference terminal devices and acceleration signal streams and orientation signal streams collected from the reference terminal devices may be built. Once the machine learning model is trained, the acceleration signal stream 330 and the orientation signal stream 1230 may be inputted into the model to obtain the device orientation 922.

Further, the deviation degree 1020 may be determined, and reference will be made back to FIG. 11 for details. At a block 1120, the deviation degree 1020 is determined based on the at least one signal stream 1010. Here the deviation degree 1020 represents a deviation between the movement orientation 912 of the user 910 and an actual device orientation of the terminal device 920. In one example implementation of the present disclosure, machine learning techniques may be used to determine the deviation degree 1020. As illustrated in FIG. 12, a machine learning module 1210 may be provided for determining parameters associated with the movement orientation 912. Here, the machine learning module 1210 may include a deviation model 1220 for determining the deviation degree 1020 and an orientation model 1240.

In one implementation of the present disclosure, the deviation degree 1020 may be associated with an angle difference. Specifically, the deviation degree 1020 for the i^{th} frame in the signal stream 1010 may be determined based on Formula 18 as below.

DevDegreeᵢ=|βᵢ| Formula 18

Where DevDegreeᵢ represents the deviation degree 1020 for the i^{th} frame in the signal stream 1010, and βᵢ represents the angle difference for the i^{th} frame.

Here, the angle difference may be estimated from the deviation model 1220 in FIG. 12. The deviation model 1220 may characterize an association between angle differences collected for reference users and signal streams collected from terminal devices carried by the reference users. An angle difference in the angle differences is between a movement orientation of a reference user and an actual device orientation of a terminal device of the reference user. Generally speaking, the deviation degree 1020 may be in proportion to the angle difference, and it will increase with an increase of the angle difference. It is to be understood that the present disclosure does not limit ways for building the machine learning models. In one example, the deviation model 1220 may be built based on the ResNet architecture and a fully connected layer may be used at the end to predict the angle difference during the movement.

In order to train the deviation model 1220, a sample dataset for reference users may be collected. The sample dataset may comprise a plurality of samples, each of which including parameters relating to one reference user. For example, each sample may include an angle difference, an acceleration signal stream and an orientation signal stream collected during a movement of the reference user. Further, the sample dataset may be used to train the deviation model 1220 such that the trained deviation model 1220 may characterize the association between angle differences and signal streams. Next, the acceleration signal stream 330 and the orientation signal stream 1230 for the user 910 may be processed and then inputted into the deviation model 1220 to obtain the angle difference.

With the above implementation, historical experiences about associations between angle differences and signal streams may be utilized to train the deviation model 1220. In turn, the deviation model 1220 may provide solid knowledge in estimating the angle difference during the movement of the user 910.

In one implementation of the present disclosure, the deviation degree 1020 may also be associated with the movement orientation estimation 1030 of the user 910 and the device orientation 922. Specifically, the deviation degree 1020 for the i^{th} frame in the signal stream 1010 may be determined based on Formula 19 as below.

DevDegreeᵢ=|βᵢ−(θᵢ−αᵢ)| Formula 19

Where DevDegreeᵢ represents the deviation degree 1020 for the i^{th} frame in the signal stream 1010, βᵢ represents the angle difference for the i^{th} frame, θᵢ represents the movement orientation estimation for the i^{th} frame, and αᵢ represents the device orientation for the i^{th} frame. With the above implementation, the deviation degree 1020 also considers impacts of the movement orientation and the device orientation, and thus a more accurate deviation degree 1020 may be obtained.

Here, an orientation model 1240 may be built for providing the movement orientation estimation 1030. The orientation model 1240 may be built based on the (Long Short Term Memory, LSTM) architecture to estimate the movement orientation. Here, a 2D vector of sin( ) an cos( ) functions related to each frame in the signal stream 1010 and movement orientations collected for reference users may be used to train the orientation model 1240.

In training the orientation model 1240, a sample dataset related with reference the users may be collected. The sample dataset may comprise a plurality of samples, each of which relating to one reference user. Each sample may include actual movement orientation of the reference user, as well as an acceleration signal stream and an orientation signal stream collected during a movement of the reference user. Further, the sample dataset may be used to train the orientation model 1240 such that the trained orientation model 1240 may characterize the association between movement orientations and signal streams. Then, the acceleration signal stream 330 and the orientation signal stream 1230 from the user 910 may be received and then inputted into the orientation model 1240 to obtain the movement orientation estimation 1030.

With the above implementation, historical experiences about associations between movement orientation and signal streams may be utilized to train the orientation model 1240. In turn, the orientation model 1240 may provide solid knowledge in estimating the movement orientation during the movement of the user 910.

It is to be understood that FIG. 12 illustrates only a procedure for processing the signal stream 1010 by the deviation model 1220 and the orientation model 1240 in the machine learning module 1210. In another implementation, the machine learning module 1210 may adopt a different architecture. For example, a new model characterizes an association between the deviation degrees and the signal streams may be built. At this time, the procedure for determining the deviation degree 1020 based on the above formulas may become an internal procedure of the new model. At this point, the signal stream 1010 may be directly inputted into the new model, so as to obtain the corresponding deviation degree.

It is to be understood that, movement orientations for two stepping events may be different during the movement of the user 910, and thus the orientation model 1240 may be trained on a basis of stepping events. Accordingly, a step signal fragment may be extracted from the signal stream in the sample dataset based on a stepping event. Here, the stepping event may be identified according to the method 300 as described in the preceding paragraphs, and a first signal fragment and a second signal fragment respectively within a first time window and a second time window may be obtained from the acceleration signal stream of the reference user. Alternatively and/or in addition to, the stepping event may be identified based on other ways.

At this point, each sample in the sample dataset may be related to a plurality of stepping events, and include respective step signal fragments and respective movement orientations for respective stepping events. Then, the orientation model 1240 may be trained on the basis of stepping events so as to characterize an association between movement orientations and signal fragments for stepping events. Once the orientation model 1240 is successfully trained, a step signal fragment may be extracted from the acceleration signal stream 330 and then inputted into the orientation model 1240 to obtain the movement orientation estimation.

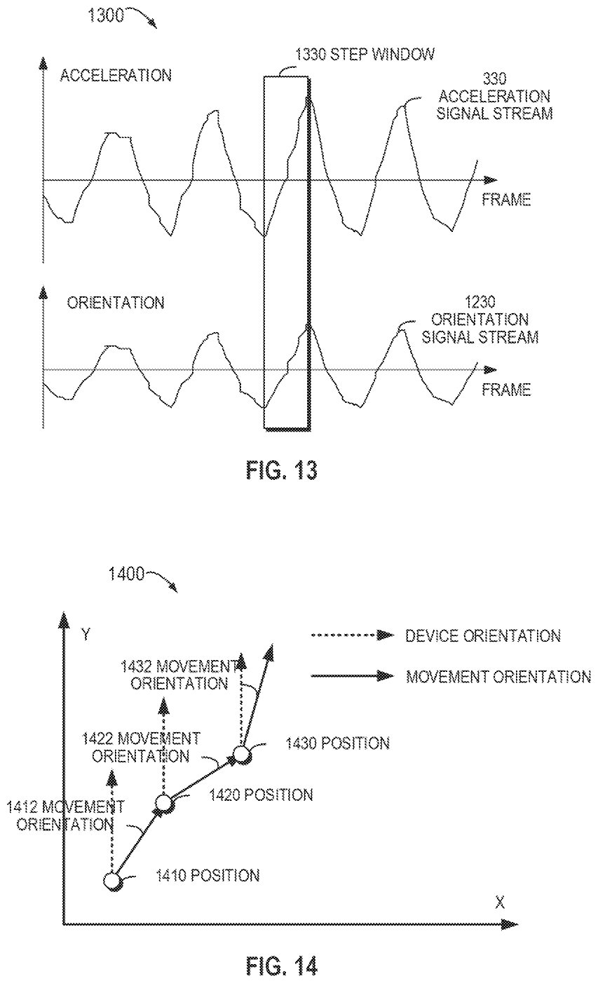

In order to extract the step signal fragment from the acceleration signal stream 330, a first signal fragment and a second signal fragment may be obtained respectively, and the extracted signal fragments may be used for identifying a stepping event. Specifically, the method 300 may be implemented to identify the stepping event, and then a step window associated with the stepping event may be determined. Reference will be made to FIG. 13 for more details about extracting the step signal fragment from the signal stream 1010.

FIG. 13 illustrates a block diagram 1300 of a step window associated with a stepping event of a user in accordance with an example implementation of the present disclosure. In FIG. 13, the acceleration signal stream 330 and the orientation signal stream 1230 are collected in parallel, and thus a step window 1330 detected from the acceleration signal stream 330 based on the method 300 may also be used to the orientation signal stream 1230. Fragments within the step window 1330 from the acceleration signal stream 330 and the orientation signal stream 1230 may be respectively inputted into the orientation model 1240 to obtain a corresponding movement orientation for the identified stepping event. With the above implementation, the movement orientation may be determined for each of the stepping events, therefore the accuracy and performance may be further enhanced.

It is to be understood that the speed of the user 910 is also an important factor of the movement. The greater the speed is, the greater impacts will be caused in a deviation in the trajectory of the user 910. For example, even if the angle difference is small, a trajectory deviation may reach a greater value when the user 910 moves fast. While if the angle difference is great and the user walks very slow and is almost still, the trajectory deviation may be low. Therefore, in one implementation of the present disclosure, the deviation degree 1020 may also be associated with the speed of the user 910. Specifically, the deviation degree 1020 for the i^{th} frame in the signal stream 1010 may be determined based on Formula 20 as below.

DevDegreeᵢ=νᵢ×|β_{di}−(θᵢ−αᵢ)| Formula 20

Where DevDegreeᵢ represents the deviation degree 1020 for the i^{th} frame in the signal stream 1010, νᵢ represents the speed of the user 910 for the i^{th} frame, βᵢ represents the angle difference for the i^{th} frame, θᵢ represents the movement orientation estimation for the i^{th} frame, αᵢ represents the device orientation for the i^{th} frame. It is to be understood that the deviation degree 1020 is a scalar value and thus the speed νᵢ may comprise only a numerical value of the speed without considering an orientation.

In this implementation, the speed may be determined based on methods described in the above paragraphs. Alternatively, and/or in addition to, the speed may be obtained from a machine learning model. For example, the deviation model 1220 may be modified to also include an association between speeds and signal streams for the reference users. Then, the speed of the user 910 may be obtained based on the deviation model 1220 and the signal stream 1010 for the user 910. With the above Formula 20, the speed of the user is also considered in determining the deviation degree 1020, and thus a more reliable and accurate deviation degree 1020 may be obtained.

Once the deviation degree 1020 is determined, the movement orientation 912 may be determined based on a comparison of the deviation degree 1020 and the threshold degree 1022. Referring back to FIG. 11, at a block 1130, the movement orientation 912 is determined based on the device orientation 922 in accordance with a determination that the deviation degree 1020 is below the threshold degree 1022. It is to be understood that a lower deviation degree may indicate that the movement orientation 912 is relatively consistent with the device orientation 922. Therefore the device orientation 922 may be directly used as the movement orientation 912. With this implementation, potential errors caused deviations between the movement and device orientations may be reduced effectively.

In one example implementation of the present disclosure, if the deviation degree 1020 exceeds the threshold degree 1022, the movement orientation 912 is determined based on the movement orientation estimation 1030. At this point, as the device orientation 922 significantly differs from the actual movement orientation, the movement orientation estimation 1030 obtained from the orientation model 1240 may be used as the movement orientation 912. Due to the movement orientation estimation 1030 is based on correct historical knowledge included in the orientation model 1240, the movement orientation estimation 1030 may be very close to the actual movement orientation and thus increase the accuracy for movement determination.

Although the above paragraphs have described the procedures for identifying the stepping event, determining the step length and determining the movement orientation in multiple implementations, these implementations may be combined together to form another implementation. For example, based on the above implementations, the movement of the user including both the speed and the orientation may be determined, and then the trajectory may be obtained.

In one implementation of the present disclosure, the above methods 300 and 1100 may be repeated for each stepping event, and thus a trajectory of the user 910 may be obtained. FIG. 14 illustrates a block diagram 1400 of a trajectory of a user in accordance with an example implementation of the present disclosure. In FIG. 14, three positions in the user's trajectory are illustrated, where the user 910 may walk a first step at a position 1410. The above method 300 may be implemented for identifying the first, and the above method 1100 may be implemented for determining a movement orientation for the first step. Supposing the deviation degree exceeds the threshold deviation, the movement orientation 1412 is set to a movement orientation estimation for the first step. Based on the step length determined according to the above method 300 and the movement orientation 1412, a position 1420 is determined.

At the position 1420, the user 910 may walk a second step toward another orientation. Supposing a deviation degree for the second step also exceeds the threshold deviation, the movement orientation 1422 is also set to a movement orientation estimation, and then the user 910 reaches a position 430. Further, the user 910 may walk a third step. Supposing a deviation degree for the third step is below the threshold deviation, the movement orientation 1432 is set to the device orientation. With the above implementation, the trajectory may be determined for the indoor navigation.

In accordance with an example implementation of the present disclosure, the above implementations for indoor navigation may be combined with the outdoor navigation. For example, two navigation modes may be provided in the navigator 110, the GPS sensor may be used in the outdoor navigation mode and the acceleration and orientation sensors may be utilized to support the indoor navigation.

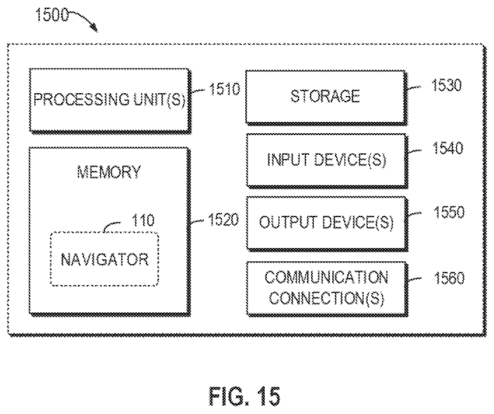

Although implementations of the present disclosure are described by taking the terminal device as an example processing device, the implementations may be performed on a general processing device. FIG. 15 is a block diagram 1500 of a device suitable for implementing one or more implementations of the present disclosure. It is to be understood that the device 1500 is not intended to suggest any limitation as to scope of use or functionality of the present disclosure, as various implementations may be implemented in diverse general-purpose or special-purpose computing environments.

As shown, the device 1500 includes at least one processing unit (or processor) 1510 and a memory 1520. The processing unit 1510 executes computer-executable instructions and may be a real or a virtual processor. In a multi-processing system, multiple processing units execute computer-executable instructions to increase processing power. The memory 1520 may be volatile memory (e.g., registers, cache, RAM), non-volatile memory (e.g., ROM, EEPROM, flash memory), or some combination thereof.

In the example shown in FIG. 15, the device 1500 further includes storage 1530, one or more input devices 1540, one or more output devices 1550, and one or more communication connections 1560. An interconnection mechanism (not shown) such as a bus, controller, or network interconnects the components of the device 1500. Typically, operating system software (not shown) provides an operating environment for other software executing in the device 1500, and coordinates activities of the components of the device 1500.

The storage 1530 may be removable or non-removable, and may include computer-readable storage media such as flash drives, magnetic disks or any other medium which can be used to store information and which can be accessed within the device 1500. The input device(s) 1540 may be one or more of various different input devices. For example, the input device(s) 1540 may include a user device such as a mouse, keyboard, trackball, etc. The input device(s) 1540 may implement one or more natural user interface techniques, such as speech recognition or touch and stylus recognition. As other examples, the input device(s) 1540 may include a scanning device; a network adapter; or another device that provides input to the device 1500. The output device(s) 1550 may be a display, printer, speaker, network adapter, or another device that provides output from the device 1500. The input device(s) 1540 and output device(s) 1550 may be incorporated in a single system or device, such as a touch screen or a virtual reality system.

The communication connection(s) 1560 enables communication over a communication medium to another computing entity. Additionally, functionality of the components of the device 1500 may be implemented in a single computing machine or in multiple computing machines that are able to communicate over communication connections. Thus, the device 1500 may operate in a networked environment using logical connections to one or more other servers, network PCs, or another common network node. By way of example, and not limitation, communication media include wired or wireless networking techniques.

In accordance with one implementation of the present disclosure, the navigator 110 may be executed on the device 1500 to identify the stepping event, determine the step length and the movement orientation of the user. Further, the navigator 110 may provide the speed and trajectory of the user.

Now only for the purpose of illustration, some example implemented will be listed below.

In accordance with one implementation of the present disclosure, a computer-implemented method is provided for indoor navigation. The method comprises: obtaining a first signal fragment and a second signal fragment respectively within a first time window and a second time window in an acceleration signal stream, the acceleration signal stream being collected from an acceleration sensor associated with a moving user, the first time window being shorter than the second time window; determining a first amplitude feature and a second amplitude feature for the first and second time windows based on the first and second signal fragments, respectively; and identifying a stepping event of the user based on a deviation between the first and second amplitude features.

In accordance with one implementation of the present disclosure, the first time window is within the second time window and has a same end as the second time window.

In accordance with one implementation of the present disclosure, determining the first amplitude feature comprises determining the first amplitude feature based on an average value of the first signal fragment.

In accordance with one implementation of the present disclosure, identifying the stepping event comprises: determining the deviation based on a difference between the first and second amplitude features; and identifying the stepping event in accordance with a determination that the deviation exceeds a threshold deviation.

In accordance with one implementation of the present disclosure, identifying the stepping event further comprises: moving the first and second time windows forward along the acceleration signal stream, respectively; determining a step intensity associated with movements of the first and second time windows based on a first group of signal fragments and a second groups of signal fragments obtained during the movements; and identifying the stepping event in accordance with a determination that the step intensity exceeds a threshold intensity.

In accordance with one implementation of the present disclosure, determining the step intensity comprises: determining a first group of amplitude features and a second group of amplitude features based on the first and second groups of signal fragments, respectively; and obtaining a summation of a group of deviations between the first and second groups of amplitude features.

In accordance with one implementation of the present disclosure, the method further comprises: determining, based on measurements in a plurality of dimensions of the acceleration signal stream, respective acceleration amplitudes for frames in the acceleration signal stream; and verifying the stepping event in accordance with a determination that an acceleration amplitude for a frame, at which the stepping event is identified, exceeds a threshold amplitude.

In accordance with one implementation of the present disclosure, the method further comprises: verifying the stepping event in accordance with a determination that a frequency of the stepping event is within a frequency limitation.

In accordance with one implementation of the present disclosure, the method further comprises: determining a step length associated with the stepping event based on a step length model characterizing an association between step lengths of reference users and acceleration signal streams collected by acceleration sensors carried by the reference users.

In accordance with one implementation of the present disclosure, determining the step length comprises: identifying, from the acceleration signal stream, an extreme value within a stepping window associated with the stepping event; determining an average value for the stepping window; and determining the step length based on the step length model, the extreme value, the average value, and a frequency of the stepping event.

In accordance with one implementation of the present disclosure, the step length model characterizes a polynomial association between a step length of a reference user in the reference users, an extreme value, an average value, and a frequency of an acceleration signal stream collected by an acceleration sensor associated with the reference user.

In accordance with one implementation of the present disclosure, the method further comprises: obtaining an orientation signal stream collected by an orientation sensor associated with the user; determining a movement orientation associated with the stepping event based on the acceleration signal stream and the orientation signal stream; and determining a trajectory of the user based on the movement orientation and the step length.

In accordance with one implementation of the present disclosure, an electronic device for indoor navigation. The device comprises: a processing unit; and a memory coupled to the processing unit and storing instructions for execution by the processing unit, the instructions, when executed by the processing unit, causing the device to perform acts comprising: obtaining a first signal fragment and a second signal fragment respectively within a first time window and a second time window in an acceleration signal stream, the acceleration signal stream being collected from an acceleration sensor associated with a moving user, the first time window being shorter than the second time window; determining a first amplitude feature and a second amplitude feature for the first and second time windows based on the first and second signal fragments, respectively; and identifying a stepping event of the user based on a deviation between the first and second amplitude features.

In accordance with one implementation of the present disclosure, the first time window is within the second time window and has a same end as the second time window.

In accordance with one implementation of the present disclosure, determining the first amplitude feature comprises determining the first amplitude feature based on an average value of the first signal fragment.

In accordance with one implementation of the present disclosure, identifying the stepping event comprises: determining the deviation based on a difference between the first and second amplitude features; and identifying the stepping event in accordance with a determination that the deviation exceeds a threshold deviation.

In accordance with one implementation of the present disclosure, identifying the stepping event further comprises: moving the first and second time windows forward along the acceleration signal stream, respectively; determining a step intensity associated with movements of the first and second time windows based on a first group of signal fragments and a second groups of signal fragments obtained during the movements; and identifying the stepping event in accordance with a determination that the step intensity exceeds a threshold intensity.

In accordance with one implementation of the present disclosure, determining the step intensity comprises: determining a first group of amplitude features and a second group of amplitude features based on the first and second groups of signal fragments, respectively; and obtaining a summation of a group of deviations between the first and second groups of amplitude features.

In accordance with one implementation of the present disclosure, the acts further comprise: determining, based on measurements in a plurality of dimensions of the acceleration signal stream, respective acceleration amplitudes for frames in the acceleration signal stream; and verifying the stepping event in accordance with a determination that an acceleration amplitude for a frame, at which the stepping event is identified, exceeds a threshold amplitude.

In accordance with one implementation of the present disclosure, the acts further comprise: verifying the stepping event in accordance with a determination that a frequency of the stepping event is within a frequency limitation.

In accordance with one implementation of the present disclosure, the acts further comprise: determining a step length associated with the stepping event based on a step length model characterizing an association between step lengths of reference users and acceleration signal streams collected by acceleration sensors carried by the reference users.

In accordance with one implementation of the present disclosure, determining the step length comprises: identifying, from the acceleration signal stream, an extreme value within a stepping window associated with the stepping event; determining an average value for the stepping window; and determining the step length based on the step length model, the extreme value, the average value, and a frequency of the stepping event.

In accordance with one implementation of the present disclosure, the step length model characterizes a polynomial association between a step length of a reference user in the reference users, an extreme value, an average value, and a frequency of an acceleration signal stream collected by an acceleration sensor associated with the reference user.

In accordance with one implementation of the present disclosure, the acts further comprise: obtaining an orientation signal stream collected by an orientation sensor associated with the user; determining a movement orientation associated with the stepping event based on the acceleration signal stream and the orientation signal stream; and determining a trajectory of the user based on the movement orientation and the step length.

In accordance with one implementation of the present disclosure, a computer program product is provided for indoor navigation. The computer program product comprises a computer-readable storage medium having program instructions embodied therewith, the program instructions being executable by an electronic device to cause the electronic device to perform a method for indoor navigation.

In accordance with one implementation of the present disclosure, a computer-readable storage medium is provided for indoor navigation. The medium has program instructions embodied therewith, the program instructions being executable by an electronic device to cause the electronic device to perform a method for indoor navigation.

In accordance with one implementation of the present disclosure, a computer-implemented method is provided for indoor navigation. The method comprises: obtaining a device orientation of a terminal device based on at least one signal stream collected from the terminal device carried by a moving user; determining, based on the at least one signal stream, a deviation degree representing a deviation between a movement orientation of the user and an actual device orientation of the terminal device; and determining the movement orientation based on the device orientation in accordance with a determination that the deviation degree is below a threshold degree.

In accordance with one implementation of the present disclosure, determining the deviation degree comprises: obtaining a movement orientation estimation of the user based on the at least one signal stream; obtaining an angle difference estimation between the movement orientation and the actual device orientation; and determining the deviation degree based on the device orientation, the movement orientation estimation, and the angle difference estimation.

In accordance with one implementation of the present disclosure, the method further comprises: in accordance with a determination that the deviation degree exceeds the threshold degree, determining the movement orientation based on the movement orientation estimation.

In accordance with one implementation of the present disclosure, obtaining the movement orientation estimation comprises: obtaining an orientation model characterizing an association between movement orientations of reference users and signal streams collected from terminal devices of the reference users; and obtaining the movement orientation estimation based on the orientation model and the at least one signal stream of the user.

In accordance with one implementation of the present disclosure, obtaining the movement orientation estimation further comprises: identifying in the at least one signal stream a step window associated with a stepping event of the user; and obtaining the movement orientation estimation based on the orientation model and a step signal fragment within the step window in the signal stream.

In accordance with one implementation of the present disclosure, the at least one signal stream comprises an acceleration signal stream acquired by an acceleration sensor in the terminal device and an orientation signal stream acquired by an orientation sensor in the terminal device.

In accordance with one implementation of the present disclosure, the stepping event is identified by: obtaining a first signal fragment and a second signal fragment respectively within a first time window and a second time window from the acceleration signal stream; and identifying the stepping event based on a comparison of the first and second signal fragments.

In accordance with one implementation of the present disclosure, obtaining the angle difference estimation comprises: obtaining an deviation model characterizing an association between angle differences of reference users and signal streams collected from terminal devices of the reference users, an angle difference in the angle differences being between a movement orientation of a reference user of the reference users and an actual device orientation of a terminal device of the reference user; and obtaining the angle difference estimation based on the deviation model and the at least one signal stream of the user.

In accordance with one implementation of the present disclosure, obtaining the deviation degree further comprises: determining a movement speed of the user based on the at least one signal stream; and obtaining the deviation degree based on the movement speed, the device orientation, the movement orientation estimation, and the angle difference estimation.

In accordance with one implementation of the present disclosure, the method further comprises: determining a trajectory of the user based on the movement orientation and the movement speed.

In accordance with one implementation of the present disclosure, an electronic device is provided for indoor navigation. The device comprises: a processing unit; and a memory coupled to the processing unit and storing instructions for execution by the processing unit, the instructions, when executed by the processing unit, causing the device to perform acts comprising: obtaining a device orientation of a terminal device based on at least one signal stream collected from the terminal device carried by a moving user; determining, based on the at least one signal stream, a deviation degree representing a deviation between a movement orientation of the user and an actual device orientation of the terminal device; and determining the movement orientation based on the device orientation in accordance with a determination that the deviation degree is below a threshold degree.

In accordance with one implementation of the present disclosure, determining the deviation degree comprises: obtaining a movement orientation estimation of the user based on the at least one signal stream; obtaining an angle difference estimation between the movement orientation and the actual device orientation; and determining the deviation degree based on the device orientation, the movement orientation estimation, and the angle difference estimation.

In accordance with one implementation of the present disclosure, the acts further comprise: in accordance with a determination that the deviation degree exceeds the threshold degree, determining the movement orientation based on the movement orientation estimation.

In accordance with one implementation of the present disclosure, obtaining the movement orientation estimation comprises: obtaining an orientation model characterizing an association between movement orientations of reference users and signal streams collected from terminal devices of the reference users; and obtaining the movement orientation estimation based on the orientation model and the at least one signal stream of the user.

In accordance with one implementation of the present disclosure, obtaining the movement orientation estimation further comprises: identifying in the at least one signal stream a step window associated with a stepping event of the user; and obtaining the movement orientation estimation based on the orientation model and a step signal fragment within the step window in the signal stream.

In accordance with one implementation of the present disclosure, the at least one signal stream comprises an acceleration signal stream acquired by an acceleration sensor in the terminal device and an orientation signal stream acquired by an orientation sensor in the terminal device.

In accordance with one implementation of the present disclosure, the stepping event is identified by: obtaining a first signal fragment and a second signal fragment respectively within a first time window and a second time window from the acceleration signal stream; and identifying the stepping event based on a comparison of the first and second signal fragments.

In accordance with one implementation of the present disclosure, obtaining the angle difference estimation comprises: obtaining an deviation model characterizing an association between angle differences of reference users and signal streams collected from terminal devices of the reference users, an angle difference in the angle differences being between a movement orientation of a reference user of the reference users and an actual device orientation of a terminal device of the reference user; and obtaining the angle difference estimation based on the deviation model and the at least one signal stream of the user.

In accordance with one implementation of the present disclosure, obtaining the deviation degree further comprises: determining a movement speed of the user based on the at least one signal stream; and obtaining the deviation degree based on the movement speed, the device orientation, the movement orientation estimation, and the angle difference estimation.

In accordance with one implementation of the present disclosure, the acts further comprise: determining a trajectory of the user based on the movement orientation and the movement speed.

In accordance with one implementation of the present disclosure, a computer program product is provided for indoor navigation. the computer program product comprises a computer-readable storage medium having program instructions embodied therewith, the program instructions being executable by an electronic device to cause the electronic device to perform a method for indoor navigation.

In accordance with one implementation of the present disclosure, a computer-readable storage medium is provided In accordance with one implementation of the present disclosure. The medium has program instructions embodied therewith, the program instructions being executable by an electronic device to cause the electronic device to perform a method for indoor navigation.

Implementations of the present disclosure may further include one or more computer program products being tangibly stored on a non-transient machine-readable medium and comprising machine-executable instructions. The instructions, when executed on a device, causing the device to carry out one or more processes as described above.

In general, the various example implementations may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example implementations of the present disclosure are illustrated and described as block diagrams, flowcharts, or using some other pictorial representation, it will be to be understood that the blocks, apparatus, systems, techniques or methods described herein may be implemented in, as non-limiting examples, hardware, software, firmware, special purpose circuits or logic, general purpose hardware or controller or other computing devices, or some combination thereof.

In the context of the present disclosure, a machine readable medium may be any tangible medium that can contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to a processor of a general purpose computer, special purpose computer, or other programmable data processing apparatus, such that the program codes, when executed by the processor of the computer or other programmable data processing apparatus, cause the functions or operations specified in the flowcharts and/or block diagrams to be implemented. The program code may execute entirely on a computer, partly on the computer, as a stand-alone software package, partly on the computer and partly on a remote computer or entirely on the remote computer or server.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of any disclosure or of what may be claimed, but rather as descriptions of features that may be specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable sub-combination.

Various modifications, adaptations to the foregoing example implementations of this disclosure may become apparent to those skilled in the relevant arts in view of the foregoing description, when read in conjunction with the accompanying drawings. Any and all modifications will still fall within the scope of the non-limiting and example implementations of this disclosure. Furthermore, other implementations of the disclosures set forth herein will come to mind to one skilled in the art to which these implementations of the disclosure pertain having the benefit of the teachings presented in the foregoing descriptions and the drawings. Therefore, it will be to be understood that the implementations of the disclosure are not to be limited to the specific implementations disclosed and that modifications and other implementations are intended to be included within the scope of the appended claims. Although specific terms are used herein, they are used in a generic and descriptive sense only and not for purposes of limitation.

1. A computer-implemented method, comprising:
obtaining a device orientation of a terminal device based on at least one signal stream collected from the terminal device carried by a moving user;
determining, based on the at least one signal stream, a deviation degree representing a deviation between a movement orientation of the user and an actual device orientation of the terminal device; and
determining the movement orientation based on the device orientation in accordance with a determination that the deviation degree is below a threshold degree.

2. The method of claim 1, wherein determining the deviation degree comprises:
obtaining a movement orientation estimation of the user based on the at least one signal stream;
obtaining an angle difference estimation between the movement orientation and the actual device orientation; and
determining the deviation degree based on the device orientation, the movement orientation estimation, and the angle difference estimation.

3. The method of claim 2, further comprising:
in accordance with a determination that the deviation degree exceeds the threshold degree, determining the movement orientation based on the movement orientation estimation.

4. The method of claim 2, wherein obtaining the movement orientation estimation comprises:
obtaining an orientation model characterizing an association between movement orientations of reference users and signal streams collected from terminal devices of the reference users; and
obtaining the movement orientation estimation based on the orientation model and the at least one signal stream of the user.

5. The method of claim 4, wherein obtaining the movement orientation estimation further comprises:
identifying in the at least one signal stream a step window associated with a stepping event of the user; and
obtaining the movement orientation estimation based on the orientation model and a step signal fragment within the step window in the signal stream.

6. The method of claim 5, wherein the at least one signal stream comprises an acceleration signal stream acquired by an acceleration sensor in the terminal device and an orientation signal stream acquired by an orientation sensor in the terminal device.

7. The method of claim 6, wherein the stepping event is identified by:
obtaining a first signal fragment and a second signal fragment respectively within a first time window and a second time window from the acceleration signal stream; and
identifying the stepping event based on a comparison of the first and second signal fragments.

8. The method of claim 2, wherein obtaining the angle difference estimation comprises:
obtaining a deviation model characterizing an association between angle differences of reference users and signal streams collected from terminal devices of the reference users, an angle difference in the angle differences being between a movement orientation of a reference user of the reference users and an actual device orientation of a terminal device of the reference user; and
obtaining the angle difference estimation based on the deviation model and the at least one signal stream of the user.

9. The method of claim 2, wherein obtaining the deviation degree further comprises:
determining a movement speed of the user based on the at least one signal stream; and
obtaining the deviation degree based on the movement speed, the device orientation, the movement orientation estimation, and the angle difference estimation.

10. (canceled)

11. An electronic device, comprising:
a processing unit; and
a memory coupled to the processing unit and storing instructions for execution by the processing unit, the instructions, when executed by the processing unit, causing the device to perform acts comprising:
obtaining a device orientation of a terminal device based on at least one signal stream collected from the terminal device carried by a moving user;
determining, based on the at least one signal stream, a deviation degree representing a deviation between a movement orientation of the user and an actual device orientation of the terminal device; and
determining the movement orientation based on the device orientation in accordance with a determination that the deviation degree is below a threshold degree.

12. The device of claim 11, wherein determining the deviation degree comprises:
obtaining a movement orientation estimation of the user based on the at least one signal stream;
obtaining an angle difference estimation between the movement orientation and the actual device orientation; and
determining the deviation degree based on the device orientation, the movement orientation estimation, and the angle difference estimation.

13. The device of claim 12, wherein the acts further comprise:
in accordance with a determination that the deviation degree exceeds the threshold degree, determining the movement orientation based on the movement orientation estimation.

14. The device of claim 12, wherein obtaining the movement orientation estimation comprises:
obtaining an orientation model characterizing an association between movement orientations of reference users and signal streams collected from terminal devices of the reference users; and
obtaining the movement orientation estimation based on the orientation model and the at least one signal stream of the user.

15. The device of claim 14, wherein obtaining the movement orientation estimation further comprises:
identifying in the at least one signal stream a step window associated with a stepping event of the user; and
obtaining the movement orientation estimation based on the orientation model and a step signal fragment within the step window in the signal stream.

16. The device of claim 15, wherein the at least one signal stream comprises an acceleration signal stream acquired by an acceleration sensor in the terminal device and an orientation signal stream acquired by an orientation sensor in the terminal device.

17. The device of claim 16, wherein the stepping event is identified by:
obtaining a first signal fragment and a second signal fragment respectively within a first time window and a second time window from the acceleration signal stream; and
identifying the stepping event based on a comparison of the first and second signal fragments.

18. The device of claim 12, wherein obtaining the angle difference estimation comprises:
obtaining a deviation model characterizing an association between angle differences of reference users and signal streams collected from terminal devices of the reference users, an angle difference in the angle differences being between a movement orientation of a reference user of the reference users and an actual device orientation of a terminal device of the reference user; and
obtaining the angle difference estimation based on the deviation model and the at least one signal stream of the user.

19. The device of claim 12, wherein obtaining the deviation degree further comprises:
determining a movement speed of the user based on the at least one signal stream; and
obtaining the deviation degree based on the movement speed, the device orientation, the movement orientation estimation, and the angle difference estimation.

20. The device of claim 19, wherein the acts further comprise:
determining a trajectory of the user based on the movement orientation and the movement speed.

21-22. (canceled)

23. A non-transitory computer readable medium, comprising at least one set of instructions, wherein when executed by at least one processor of a computing device, the at least one set of instructions direct the at least one processor to perform operations including:
obtaining a device orientation of a terminal device based on at least one signal stream collected from the terminal device carried by a moving user;
determining, based on the at least one signal stream, a deviation degree representing a deviation between a movement orientation of the user and an actual device orientation of the terminal device; and
determining the movement orientation based on the device orientation in accordance with a determination that the deviation degree is below a threshold degree.
